(19) United States
(12) Patent Application Publication
(10) Pub. No.: US 2024/0290978 A1
(43) Pub. Date: Aug. 29, 2024

(54) ELECTRODE FOR ALL-SOLID-STATE BATTERY

(71) Applicant: TOYOTA JIDOSHA KABUSHIKI KAISHA, Toyota-shi (JP)

(72) Inventors: Hideaki NISHIMURA, Susono-shi (JP); Toru KIDOSAKI, Miyoshi-shi (JP); Heidy Hodex VISBAL MENDOZA, Nagoya-shi (JP); Hikaru SUGANUMA, Susono-shi (JP)

(73) Assignee: TOYOTA JIDOSHA KABUSHIKI KAISHA, Toyota-shi (JP)

(21) Appl. No.: 18/403,368

(22) Filed: Jan. 3, 2024

(30) Foreign Application Priority Data
Jan. 12, 2023 (JP) 2023-003038

(51) Int. Cl. H01M 4/62; H01M 4/13; H01M 10/0562

(52) U.S. Cl. CPC H01M 4/62; H01M 4/13; H01M 10/0562; H01M 2300/0068

(57) ABSTRACT

An electrode for all-solid-state battery includes a first sulfide solid electrolyte, a second sulfide solid electrolyte, and an active material. The first sulfide solid electrolyte has an LGPS type crystal structure. The second sulfide solid electrolyte is a glass ceramic. A mass fraction of the second sulfide solid electrolyte with respect to a sum of the first sulfide solid electrolyte and the second sulfide solid electrolyte is more than 5% and 20% or less.

### CROSS REFERENCE TO RELATED APPLICATIONS

This nonprovisional application is based on Japanese Patent Application No. 2023-003038 filed on Jan. 12, 2023 with the Japan Patent Office, the entire contents of which are hereby incorporated by reference.

### BACKGROUND

### Field

The present disclosure relates to an electrode for all-solid-state battery.

### Description of the Background Art

Japanese Patent Application Laid-Open No. 2020-071902 discloses a sulfide solid electrolyte having an LGPS type crystal structure.

### SUMMARY

The sulfide solid electrolyte can have high ionic conductivity. By employing such a sulfide solid electrolyte, it is expected to reduce battery resistance. However, the sulfide solid electrolyte has room for improvement in water resistance. That is, the sulfide solid electrolyte may generate hydrogen sulfide under a wet atmosphere. Hence, the present disclosure has an object to attain both battery resistance and water resistance.
1. In one aspect of the present disclosure, an electrode for all-solid-state battery includes a first sulfide solid electrolyte, a second sulfide solid electrolyte, and an active material. The first sulfide solid electrolyte has an LGPS type crystal structure. The second sulfide solid electrolyte is a glass ceramic. A mass fraction of the second sulfide solid electrolyte with respect to a sum of the first sulfide solid electrolyte and the second sulfide solid electrolyte is more than 5% and 20% or less.

The first sulfide solid electrolyte has the LGPS type crystal structure. Hereinafter, the first sulfide solid electrolyte may be referred to as “LGPS”. The LGPS tends to be excellent in water resistance. However, the use of the LGPS tends to increase the battery resistance. Since the LGPS is hard, a filling factor of the electrode tends to be increased less likely. Since the filling factor of the electrode is low, it is considered that formation of an interface between the solid electrolyte and the active material becomes insufficient, thus resulting in the increased battery resistance.

The second sulfide solid electrolyte is the glass ceramic. Hereinafter, the second sulfide solid electrolyte may be referred to as “glass ceramic”. By mixing the glass ceramic with the LGPS, the increase in battery resistance can be reduced. The glass ceramic tends to be softer than the LGPS. It is considered that during compression of the electrode, the glass ceramic is crushed first, with the result that a clearance between the LGPS and the active material is provided with the glass ceramic. That is, it is considered that the glass ceramic promotes the formation of the interface between the solid electrolyte and the active material.

It should be noted that the mass fraction of the glass ceramic with respect to the sum of the LGPS and the glass ceramic is more than 5% and 20% or less. When the mass fraction is 5% or less, the battery resistance tends to be high. When the mass fraction is more than 20%, the water resistance may become insufficient.
2. In the electrode for all-solid-state battery according to “1”, the first sulfide solid electrolyte may be represented by, for example, the following formula (1):

Li₄₋ₓGe₁₋ₓPₓS₄ (1)

In the formula (1), a relationship of 0.55≤x≤0.76 is satisfied.

The second sulfide solid electrolyte may be represented by, for example, the following formula (2):

xLiI·yLiBr·(100−x−y)Li₃PS₄ (2).

In the formula (2), relationships of 5<x≤20, 5<y≤20, and 10<x+y<30 are satisfied.

The LGPS may include, for example, Ge. Since Ge is included in the LGPS, it is expected to improve the water resistance.

The glass ceramic can be synthesized in the following procedure. A raw material is subjected to a mechanical milling process, thereby generating a glass. By performing heat treatment onto the glass, a partially crystallized glass (i.e., glass ceramic) can be generated. The raw material may include, for example, Li₃PS₄. Hereinafter, the glass ceramic including LisPS₄ may also be referred to as “LPS”. The raw material may further include, for example, lithium halide (LiI, LiBr). Since the raw material includes the lithium halide, it is expected to reduce the battery resistance. The glass ceramic can be specified in accordance with a composition of the raw material. “xLiI·yLiBr·(100−x−y)Li₃PS₄” indicates that the raw material has a composition “LiI/LiBr/Li₃PS₄=x/y/(100−x−y)” in molar ratio.
3. In the electrode for all-solid-state battery according to “1” or “2”, the first sulfide solid electrolyte has a first average particle size. The second sulfide solid electrolyte has a second average particle size. The second average particle size may be smaller than the first average particle size. The second average particle size may be less than 0.5 μm.

Since the glass ceramic has the average particle size smaller than that of the LGPS, it is expected to improve the filling factor.
4. In the electrode for all-solid-state battery according to any one of “1” to “3”, the mass fraction of the second sulfide solid electrolyte with respect to the sum of the first sulfide solid electrolyte and the second sulfide solid electrolyte may be 10 to 20%.

When the mass fraction of the second sulfide solid electrolyte is 10 to 20%, it is expected to reduce the battery resistance.
5. In one aspect of the present disclosure, an electrode for all-solid-state battery includes a first sulfide solid electrolyte, a second sulfide solid electrolyte, and an active material. The first sulfide solid electrolyte has an LGPS type crystal structure. The second sulfide solid electrolyte is a glass ceramic. A mass fraction of the second sulfide solid electrolyte with respect to a sum of the first sulfide solid electrolyte and the second sulfide solid electrolyte is 10 to 20%. The first sulfide solid electrolyte is represented by the above formula (1). The second sulfide solid electrolyte is represented by the above formula (2). The first sulfide solid electrolyte has a first average particle size. The second sulfide solid electrolyte has a second average particle size. The second average particle size is smaller than the first average particle size. The second average particle size is 0.1 μm or less.

The following describes an embodiment of the present disclosure (hereinafter, also simply referred to as “the present embodiment”) and an example of the present disclosure (hereinafter, also simply referred to as “the present example”). It should be noted that the present embodiment and the present example do not limit the technical scope of the present disclosure. The present embodiment and the present example are illustrative in any respects. The present embodiment and the present example are non-restrictive. The technical scope of the present disclosure includes any modifications within the scope and meaning equivalent to the terms of the claims. For example, it is initially expected to extract freely configurations from the present embodiment and the present example and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual diagram of an all-solid-state battery according to the present embodiment.

FIG. 2 is a table showing experimental results.

FIG. 3 is a graph showing experimental results.

### DESCRIPTION OF THE PREFERRED EMBODIMENTS

### 1. Terms and Definitions and the Like

Some of the terms used herein are described. The terms not described herein may be defined and described herein each time the term is used.

The descriptions of “comprising,” “including,” “having,” and variations thereof (e.g., “composed of”) are open-ended. The open-end format may or may not further include additional elements in addition to essential elements. The description “consisting of” is in a closed format. However, even in the closed format, additional elements that are normally attendant impurities or that are irrelevant to the technology disclosed are not excluded. The description “consisting essentially of . . . ” is a semi-closed format. In semi-closed format, the addition of elements that do not substantially affect the basic and novel characteristics of the disclosed technology is allowed.

“A and/or B” includes “A or B” and “A and B”. “At least one of A and B” may also be referred to as “A and/or B”.

A numerical range such as “m to n %” includes an upper limit value and a lower limit value unless otherwise specified. That is, “m to n %” indicates a numerical range of “m % or more and n % or less”. Further, “m % or more and n % or less” includes “more than m % and less than n %”. The terms “more than or equal to” and “less than or equal to” are denoted by the equalized inequality “≤”. “Super” and “less than” are denoted by inequality “<” which does not include equality. A numerical value arbitrarily selected from the numerical range may be a new upper limit value or a new lower limit value. For example, a new numerical range may be set by arbitrarily combining a numerical value in the numerical range with a numerical value described in another part in the specification, a table, a drawing, or the like.

All numerical values are modified by the term “about”. The term “about” may mean, for example, ±5%, ±3%, ±1%, etc. All numerical values may be approximations that may vary depending on the application of the present disclosure.

All numerical values may be denoted by significant numbers. The measurement value may be an average value in multiple measurements unless otherwise specified. The number of measurements may be three or more, five or more, or ten or more. In general, it is expected that the higher the number of measurements, the higher the reliability of the average value. The measurements may be fractionally processed by rounding off based on the number of digits of the significant number. The measurement value may include, for example, an error associated with a detection limit of the measuring device or the like.

Stoichiometric compositional formulae represent representative examples of compounds. The compound may have a non-stoichiometric composition. For example, “Al₂O₃” is not limited to a compound having an amount-of-substance ratio (molar ratio) of “Al/O=2/3”. “Al₂O₃” represents a compound containing Al and O in an arbitrary amount-of-substance ratio unless otherwise specified. Further, for example, the compound may be doped with a trace element. A part of Al and O may be substituted with another element.

The “LGPS type crystal structure” consists of a three-dimensional skeleton. The three-dimensional skeleton includes a plurality of one-dimensional chains. Each one-dimensional chain is formed by one-dimensional connection of (Ge_{0.5}P_{0.5})S₄ tetrahedron and LiS₆ octahedron while sharing ridges. Two adjacent one-dimensional chains are linked through a PS₄ tetrahedron. In the LGPS type crystal structure, P (phosphorus atoms) may occupy 4d sites and 2b sites. The 4d site constitutes a one-dimensional chain. The 2b site constitutes a linking portion for linking one-dimensional chains. The 4d site can be occupied by Ge and P. At the 4d site, the molar ratio is “Ge/P=1/1”. The 2b site may be occupied by only P. Whether or not an object has an LGPS type crystal structure can be specified by an XRD (X-ray Diffraction) spectrum.

“Glass ceramic” refers to a material having a crystallinity of 20 to 80%. Materials with a crystallinity of less than 20% are considered “glass”. Materials with a crystallinity greater than 80% are considered “crystalline”. The crystallinity is determined by the following formula (3).

C=(S₁/S₀)×100 (3)
C: Crystallinity (%)
S₀: Sum of the area of all peaks in the NMR (Nuclear Magnetic Resonance) spectrum of the object
S₁: Area of peaks belonging to crystals in the NMR spectrum of the object

The “average particle size” indicates an average value of Feret diameters of target particles (sulfide solid electrolyte or the like) in a cross section of an electrode. “Feret diameter” is measured by microscopy. The Feret diameter indicates the distance between the two most distant points on the outline of the particle. An arithmetic average of 100 or more Feret diameters is considered an average particle size. The microscope may be an optical microscope or an electron microscope.

The “electrode for all-solid-state battery” may be abbreviated as “electrode”. The “electrode” may be a positive electrode, a negative electrode, or a bipolar electrode. The “all-solid-state battery” may be a monopolar battery or a bipolar battery.

### 2. All-Solid-State Battery

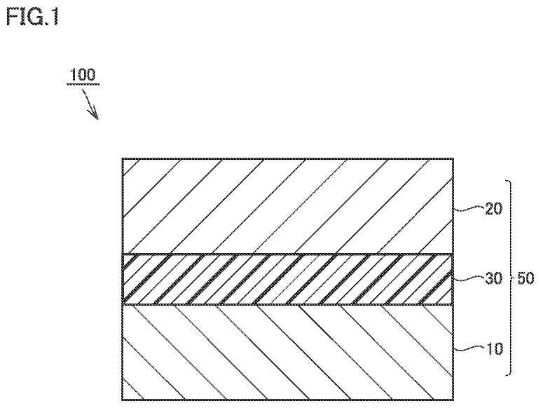

FIG. 1 is a conceptual diagram of an all-solid-state battery according to the present embodiment. The all-solid-state battery 100 includes a power generation element 50. The all-solid-state battery 100 may include an exterior body. The exterior body may house the power generation element 50. The exterior body may be, for example, a metal case, a pouch made of an Al laminate film, or the like. The power generation element 50 includes a first electrode 10, a separator 30, and a second electrode 20. The separator 30 separates the first electrode 10 from the second electrode 20. The second electrode 20 has a polarity opposite to that of the first electrode 10. When the first electrode 10 is a positive electrode, the second electrode 20 is a negative electrode. When the first electrode 10 is a negative electrode, the second electrode 20 is a positive electrode. At least one of the first electrode 10 and the second electrode 20 includes the following configuration.

### 3. Electrodes

The electrode includes an active material layer. The electrode may further include, for example, a current collector. The current collector may support the active material layer. The current collector may have a thickness of, for example, 5 to 50 μm. The current collector has conductivity. The current collector may comprise, for example, a metal foil. The metal foil may contain, for example, at least one selected from the group consisting of Al, Mn, Cu, Ni, Ti, Fe, and Cr. The metal foil may include, for example, at least one kind selected from the group consisting of Al foil, Al alloy foil, Ni foil, Ni alloy foil, Cu foil, Cu alloy foil, Ti foil, Ti alloy foil, and stainless steel foil.

The active material layer may have a thickness of, for example, 10 to 1000 μm. The active material layer includes a first sulfide solid electrolyte (LGPS), a second sulfide solid electrolyte (glass ceramic), and an active material. That is, the electrode includes LGPS, glass ceramics, and an active material. The active material layer may further include, for example, a conductive material, a binder, and the like in addition to the active material and the like.

The active material layer may have a high filling factor. The filling factor of the active material layer may be 90% or more, 92.3% or more, or 93.4% or more, for example. The filling factor may be, for example, 100% or less, 99% or less, 95% or less, or 93.4% or less. The filling factor is obtained by the following formula (4).

φ=(v₀/v₁)×100 (4)
φ: Filling factor (%)
v₀: Volume of the active material layer obtained from the true density of each material contained in the active material layer
v₁: Volume (apparent volume) of the active material layer obtained from the outer dimension (area, thickness) of the active material layer

### 3-1. Active Material

The active material may have, for example, an average particle size of 1 to 30 μm. The active material may be a positive electrode active material or a negative electrode active material. The positive electrode active material may include at least one selected from the group consisting of, for example, LiCoO₂, LiNiO₂, LiMnO₂, LiMn₂O₄, Li(NiCoMn)O₂ “NCM”, Li(NiCoAl)O₂ “NCA”, Li(NiCoMnAl)O₂, and LiFePO₄. For example, “(NiCoMn)” in “Li(NiCoMn)O₂” indicates that the sum of molar ratios of the elements (Ni, Co, Mn) in parentheses is 1. The positive electrode active material may be coated with, for example, an oxide solid electrolyte. The oxide solid electrolyte may contain, for example, at least one selected from the group consisting of LiNbO₃, Li₃PO₄, and Li₃BO₃.

The negative electrode active material may contain, for example, at least one selected from the group consisting of natural graphite, artificial graphite, soft carbon, hard carbon, Si, SiOₓ (0<x<2), Si-based alloy, Sn, SnOₓ (0<x<2), Li, Li-based alloy, and Li₄Ti₅O₁₂.

### 3-2. Sulfide Solid Electrolyte

Sulfide solid electrolytes may form ionic conductive paths in the active material layer. The volume ratio of the active material to the sulfide solid electrolyte may be, for example, “active material/sulfide solid electrolyte=60/40 to 80/20”. The active material layer in this embodiment includes two kinds of sulfide solid electrolytes. That is, the active material layer includes LGPS and LPS.

### 3-3. Mass Fraction of LPS

The mass fraction of LPS relative to the sum of LGPS and LPS is greater than 5% and no greater than 20%. When the same mass fraction is greater than 5% and equal to or less than 20%, it is expected that both battery resistance and water resistance are satisfied. The same mass fraction may be, for example, 7.5% or more, 10% or more, or 15% or more. The same mass fraction may be, for example, 15% or less and 12.5% or less. The same mass fraction may be, for example, 10 to 20%.

### 3-4. LGPS

The LGPS may have, for example, a composition represented by the general formula “Li₄₋ₓGe₁₋ₓPₓS₄”. x may be, for example, 0.55 to 0.76. x may be, for example, 0.6 or more, 0.65 or more, or 0.7 or more. x may be, for example, 0.75 or less, 0.7 or less, 0.65 or less, or 0.6 or less.

### 3-5. LPS

The LPS may have, for example, a composition represented by the general formula “xLiI·yLiBr·(100−x−y)Li₃PS₄”. x may be, for example, greater than 5 and less than or equal to 20. x may be, for example, 7.5 or more, 10 or more, or 15 or more. x may be, for example, less than or equal to 15, less than or equal to 10, or less than or equal to 7.5. y may be, for example, greater than 5 and less than or equal to 20. y may be, for example, 7.5 or more, 10 or more, or 15 or more. y may be, for example, less than or equal to 15, less than or equal to 10, or less than or equal to 7.5. x+y may be greater than 10 and less than 30, for example. x+y may be, for example, 15 or more, 20 or more, or 25 or more. x+y may be, for example, less than or equal to 25, less than or equal to 20, or less than or equal to 15.

The LPS may include, for example, at least one selected from the group consisting of “10LiI·10LiBr·80Li₃PS₄”, “10LiI·15LiBr·75Li₃PS₄”, and “15LiI·10LiBr·75Li₃PS₄”.

The crystallinity of LPS is 20 to 80%. The crystallinity of LPS may be, for example, 30% or more, 40% or more, or 50% or more. The crystallinity of LPS may be, for example, 70% or less, 60% or less, or 50% or less.

### 3-6. Average Particle Size

LGPS has a first average particle size (d1). LPS has a second average particle size (d2). The active material has a third average particle size (d3). For example, the relationship “d2<d1” may be satisfied. When the relationship of “d2<d1” is satisfied, for example, an improvement in the filling factor is expected. For example, the relationship “d2<d1<d3” may be satisfied. When the relationship of “d2<d1<d3” is satisfied, for example, an improvement in the filling factor is expected. d1 may be, for example, 0.5 to 3 μm, or 0.5 to 1 μm. For example, d2 may be less than 0.5 μm, 0.3 μm or less, or 0.1 μm or less. For example, d2 may be 0.01 μm or more, or 0.05 μm or more.

### 3-7. Compressive Elastic Modulus

A “compressive elastic modulus” indicates the slope of the elastic zone in the stress-strain curve. The stress-strain curve can be measured by an indentation method. The LGPS has a first compressive elastic modulus. The LPS has a second compressive elastic modulus. For example, the second compressive elastic modulus may be lower than the first compressive elastic modulus. It is considered that the smaller the compressive elastic modulus, the easier the object is to be collapsed when the active material layer is compressed. Since the second compressive elastic modulus is smaller than the first compressive elastic modulus, the filling factor is expected to be improved. The first compressive elastic modulus may be, for example, 20 GPa or more, 25 GPa or more, or 26 GPa or more. The first compressive elastic modulus may be, for example, 50 GPa or less, 40 GPa or less, 30 GPa or less, or 26 GPa or less. The second compressive elastic modulus may be, for example, less than 20 GPa. When the compressive elastic modulus of the glass ceramic is less than 20 GPa, an improvement in the filling factor is expected. The second compressive elastic modulus may be, for example, 18 GPa or less, 15 GPa or less, or 14 GPa or less. The second compressive elastic modulus may be, for example, 1 GPa or more, 5 GPa or more, 10 GPa or more, or 14 GPa or more.

### 3-8. Conductive Materials

The conductive material may form an electron conduction path in the active material layer. The amount of the conductive material to be blended may be, for example, 0.1 to 10 parts by mass based on 100 parts by mass of the active material. The conductive material may include any component. The conductive material may include, for example, at least one selected from the group consisting of acetylene black (AB), Ketjen Black®, vapor grown carbon fiber (VGCF), carbon nanotubes (CNT), and graphene flakes (GF).

### 3-9. Binder

The binder may adhere the active material layer to the current collector. The amount of the binder to be blended may be, for example, 0.1 to 10 parts by mass based on 100 parts by mass of the active material. The binder may comprise any component. The binder include, for example, at least one selected from the group consisting of polyvinylidene difluoride (PVdF), vinylidene fluoride-hexafluoropropylene copolymer (PVdF-HFP), polytetrafluoroethylene (PTFE), carboxymethyl cellulose (CMC), polyacrylic acid (PAA), polyvinyl alcohol (PVA), polyvinylpyrrolidone (PVP), polyoxyethylene alkyl ether, styrene-butadiene rubber (SBR), and acrylate-butadiene rubber (ABR).

### Examples

### 4. Production of Electrodes

### 4-1. Preparation of Sulfide Solid Electrolyte

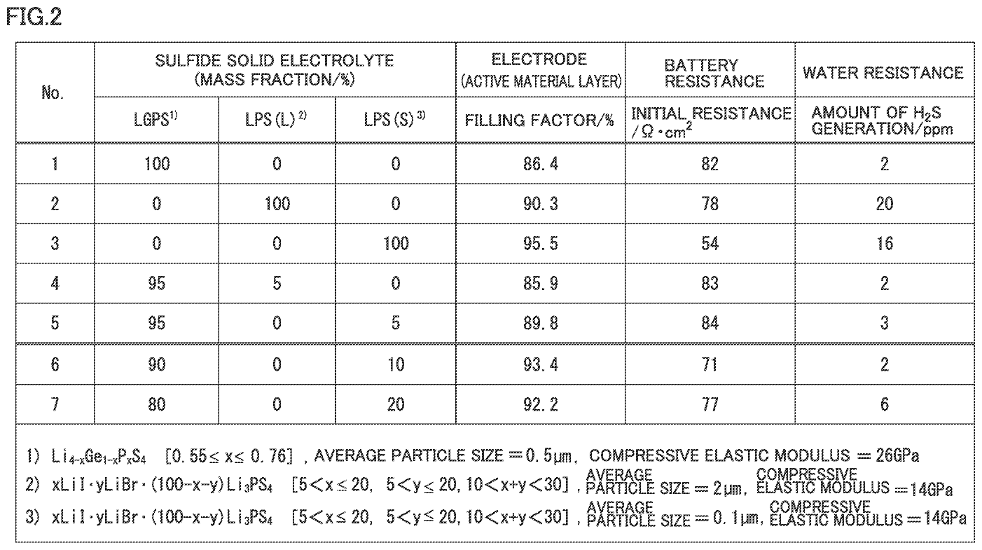

FIG. 2 is a table showing experimental results. LGPS, LPS(L) and LPS(S) in the table were prepared as sulfide solid electrolytes. LPS(L) has a larger average particle size than LPS(S). LPS(L) has the same composition as LPS(S). Each sulfide solid electrolyte was produced by the following procedure.

The composition was prepared by mixing the raw materials with a ball mill. The composition was heat treated at 200-600° C. to prepare a sulfide solid electrolyte. The particle size of the sulfide solid electrolyte was adjusted by a ball mill. Each operation was performed under a dew point environment of −70° C.

### No. 1

A slurry was prepared by mixing an active material (NCM), a sulfide solid electrolyte (LGPS), a conductive material, a binder, and a dispersion medium by a homogenizer. A slurry was applied to the current collector (Al foil) to form an active material layer. The active material layer was compressed to produce a positive electrode. Each operation was performed under a dew point environment of −70° C.

### No. 2

A positive electrode was produced in the same manner as in No. 1 except that LPS (L) was used as the sulfide solid electrolyte.

### No. 3

A positive electrode was produced in the same manner as in No. 1 except that LPS(S) was used as the sulfide solid electrolyte.

### No. 4

A positive electrode was produced in the same manner as in No. 1 except that the mixture “LGPS/LPS(L)=95/5 (mass ratio)” was used as the sulfide solid electrolyte.

### No. 5

A positive electrode was produced in the same manner as in No. 1 except that the mixture “LGPS/LPS(S)=95/5 (mass ratio)” was used as the sulfide solid electrolyte.

### No. 6, 7

A positive electrode was produced in the same manner as in No. 5, except that the mixing ratio (mass ratio) of LGPS and LPS(S) was changed.

### 5. Evaluation

### 5-1. Battery Resistance

A test battery was prepared. The ratio of the initial charge capacity of the negative electrode to the initial charge capacity of the positive electrode was 1.1 to 2. At 25° C., charge and discharge cycles were repeated four times. After the charge/discharge cycle, the initial resistance at the time of discharge for 10 seconds was measured by the I-V method.

### 5-2. Water Resistance

Water resistance was evaluated by the following procedure. In the first glove box, 10 mg of the sample is enclosed in a sealed container. The dew point in the first glove box is −70° C. or lower. The sample is a sulfide solid electrolyte used for each electrode. For example, in No. 1, LGPS is a sample. For example, in No. 6, the mixture “LGPS/LPS(S)=90/10 (mass ratio)” is a sample.

The sealed container is transferred into the second glove box. The dew point in the second glove box is greater than −70° C. and less than or equal to −30° C. In the second glove box, the sample is transferred from the sealed container to the desiccator. The inner volume of the desiccator is 1 L. A fan is mounted on an upper portion (cover) of the desiccator. An H₂S sensor is disposed in the desiccator. The desiccator is closed.

The amount of H₂S generation (H₂S concentration in the desiccator) is recorded for 5 hours while rotating the fan. The rotation of the fan prevents the H₂S from staying. The maximum value of the recorded H₂S generation amounts was regarded as the H₂S generation amount.

### 6. Results

In FIG. 2 (Table), mixing LPS with LGPS shows a tendency to improve the filling factor compared to the single use of LGPS. The smaller the average particle size of LPS, the greater the effect of improving the filling factor. When the mass fraction of LPS exceeds 5%, the initial resistance tends to be reduced compared to the single use of LGPS.

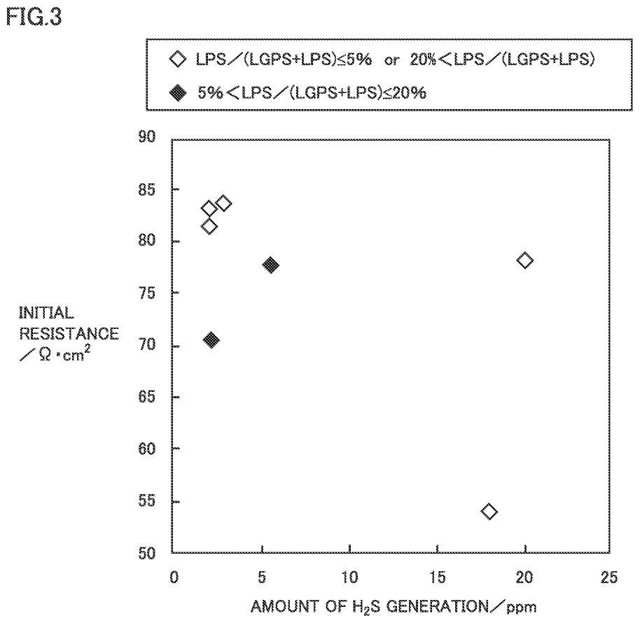

FIG. 3 is a graph showing experimental results. When the mass ratio of LPS to the sum of LGPS and LPS is greater than 5% and equal to or less than 20%, the initial resistance tends to be low and the H₂S generation amount tends to be small.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. An electrode for all-solid-state battery comprising:
a first sulfide solid electrolyte;
a second sulfide solid electrolyte; and
an active material, wherein
the first sulfide solid electrolyte has an LGPS type crystal structure,
the second sulfide solid electrolyte is a glass ceramic, and
a mass fraction of the second sulfide solid electrolyte with respect to a sum of the first sulfide solid electrolyte and the second sulfide solid electrolyte is more than 5% and 20% or less.

2. The electrode for all-solid-state battery according to claim 1, wherein
the first sulfide solid electrolyte is represented by the following formula (1):
Li₄₋ₓGe₁₋ₓPₓS₄ (1),
in the formula (1), a relationship of 0.55≤x≤0.76 is satisfied,
the second sulfide solid electrolyte is represented by the following formula (2):
xLiI·yLiBr·(100−x−y)Li₃PS₄ (2), and
in the formula (2), relationships of 5<x≤20, 5<y≤20, and 10<x+y<30 are satisfied.

3. The electrode for all-solid-state battery according to claim 1, wherein
the first sulfide solid electrolyte has a first average particle size,
the second sulfide solid electrolyte has a second average particle size,
the second average particle size is smaller than the first average particle size, and
the second average particle size is less than 0.5 μm.

4. The electrode for all-solid-state battery according to claim 1, wherein
the mass fraction of the second sulfide solid electrolyte with respect to the sum of the first sulfide solid electrolyte and the second sulfide solid electrolyte is 10 to 20%.

5. An electrode for all-solid-state battery comprising:
a first sulfide solid electrolyte;
a second sulfide solid electrolyte; and
an active material, wherein
the first sulfide solid electrolyte has an LGPS type crystal structure,
the second sulfide solid electrolyte is a glass ceramic,
a mass fraction of the second sulfide solid electrolyte with respect to a sum of the first sulfide solid electrolyte and the second sulfide solid electrolyte is 10 to 20%,
the first sulfide solid electrolyte is represented by the following formula (1):
Li₄₋ₓGe₁₋ₓPₓS₄ (1),
in the formula (1), a relationship of 0.55≤x≤0.76 is satisfied, the second sulfide solid electrolyte is represented by the following formula (2):
xLiI·yLiBr·(100−x−y)Li₃PS₄ (2),
in the formula (2), relationships of 5<x≤20, 5<y≤20, and 10<x+y<30 are satisfied,
the first sulfide solid electrolyte has a first average particle size,
the second sulfide solid electrolyte has a second average particle size,
the second average particle size is smaller than the first average particle size, and
the second average particle size is 0.1 μm or less.
